(19) United States
(12) Patent Application Publication
(10) Pub. No.: US 2020/0184590 A1
(43) Pub. Date: Jun. 11, 2020

(54) SYSTEM AND METHOD FOR PROVIDING ACCESS TO MENTORING

(71) Applicant: DAVID MARGOLIN, MOUNTAINSIDE, NJ (US)

(72) Inventor: DAVID MARGOLIN, MOUNTAINSIDE, NJ (US)

(21) Appl. No.: 16/707,456

(22) Filed: Dec. 9, 2019

Related U.S. Application Data
(60) Provisional application No. 62/777,413, filed on Dec. 10, 2018.

(51) Int. Cl. G06Q 50/20; G06F 16/9535; G06Q 10/06; G06F 3/0482

(52) U.S. Cl. CPC G06Q 50/2057; G06F 3/0482; G06Q 10/063112; G06F 16/9535

(57) ABSTRACT

A system and method for an exchange to connect people at all levels, young and old, in school and out of school, for the purpose of sharing knowledge and the goals of improving people's lives and career opportunities.

### CROSS REFERENCE TO RELATED APPLICATION

This application claims the benefit of U.S. Provisional Application No. 62/777,413 filed on Dec. 10, 2019.

### FIELD OF INVENTION

The present invention relates to an improved system and method for sharing knowledge and improving people's lives and career opportunities.

### BACKGROUND

The instant invention provides an exchange to connect people at all levels, young and old, in school and out of school, for the purpose of sharing knowledge and the goals of improving people's lives and career opportunities. Students lack the skill sets and knowledge to confidently and successfully transition from university to industry. In addition, people at all education and career levels are realizing that they need more knowledge to keep up or get ahead, but they don't know where to start or in some cases don't have access to traditional educational institutions. In many cases people are feeling overwhelmed, which only exacerbates the problem. The source of the problem is certainly not a lack of online resources, or that traditional educational institutions don't provide value, or that mentoring programs are not effective. Online resources are prevalent and in many cases fantastic and universities and colleges remain an essential part of our education system. In addition, in many cases mentoring programs provide the mentee with valuable career related information. The problem is that there does not exist an efficient, accessible, and easy to use platform (or exchange) for potential mentors (“Givers”) and those whom the Givers can help (“Takers”) to freely share their knowledge.

### SUMMARY OF THE INVENTION

The system and method disclosed herein solves problems of the following types:
1. You want to learn the Python programming language, but you feel overwhelmed by the number of online resources. Or perhaps you simply don't where to begin, or you don't what online sites are best, or the class you need isn't offered for another semester, or perhaps you simply feel more comfortable speaking to someone as opposed to using an online resource.
2. You have a big history exam next week and you don't feel comfortable asking any of your classmates for help (or perhaps you don't think they can help you).
3. You want to learn knitting, but you are not aware of any friends who know knitting (via Facebook) nor can afford to pay a tutor. You also don't really have the time to make a commitment to sign-up for a 3 month course at the local university.

There are many online tutorials and mentorship programs, but there is not a volunteer knowledge exchange that allows Givers and Takers flexibility with respect to their time commitments, the range of knowledge to be exchanged, and that does not have arbitrary registration deadlines. Finally, and perhaps most importantly, there does not exist a platform/program that combines all of these features in a free and easy to use exchange for folks of all ages and backgrounds. The instant invention brings knowledge to more people: There are too many people who are seeking knowledge and cannot get it. The problems range from those in countries where illiteracy is high, to students in highly accredited institutions who are frustrated by the curriculum, to middle aged men/women who feel lost at sea by the mind numbing speed of changes in the markets/technology. The platform of the instant invention has the power to increase the flow of knowledge and overcomes the following negatives: First, with this invention there are no arbitrary deadlines to apply for the program (as most programs have). Example: When the mentor misses the January 1 deadline he/she has to wait for the following years enrollment. Second, there are no long drawn out registration periods that often range from weeks to months. If you can share your knowledge today, and there is someone out there who would benefit from your knowledge, you should have the ability to make connection and difference right now. Third, there are no arbitrary time commitments (as most programs have). For example, one hour is required on a weekly or monthly basis, or that you must sign-up for a year. You give what you can and when you can. ‘Life happens’ and the reality is that there are periods when you have a lot of extra time and very little time. In addition, in many cases mentees will not need ‘one year commitments’—they just need help on a specific problem on a particular day. Or in some cases he or she may need help on multiple problems that can only be solved by working with more than one mentor. The bottom line is that the ‘Giver’ and the ‘Taker’ can move in and out of the program as is necessary, with no cost to the ‘Takers’. Givers post their knowledge/skill sets and availability. Takers identify the knowledge they need and submit a meeting request. Knowledge is exchanged in this manner using the system and method described herein.

### BRIEF DESCRIPTION OF THE DRAWINGS

The instant invention will become more readily apparent from the following description of the preferred embodiment thereof as shown by way of example only in the accompanying drawings:

FIG. 1 depicts a webpage for matching of potential mentors with potential mentees so that said mentors may provide mentoring services to said mentees.

FIG. 2 depicts a webpage by which a potential mentor enters his or her availability and skill set information.

FIG. 3 depicts a webpage by which a potential mentor enters his or her profile information.

FIG. 4 depicts a webpage by which a potential mentee enters his or her needed mentoring and profile information.

### DETAILED DESCRIPTION OF THE INVENTION

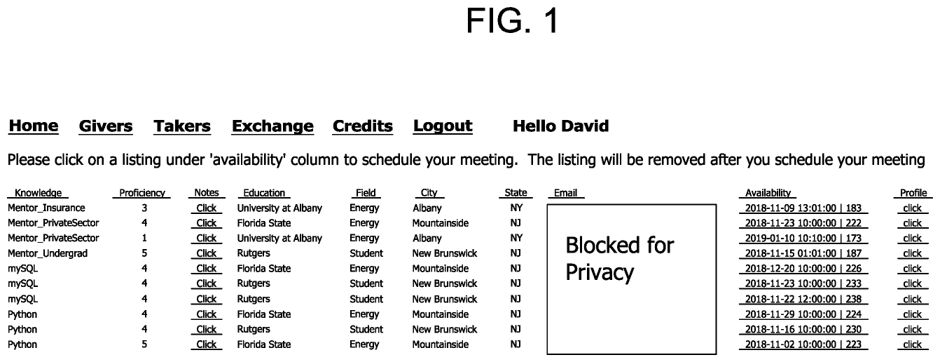

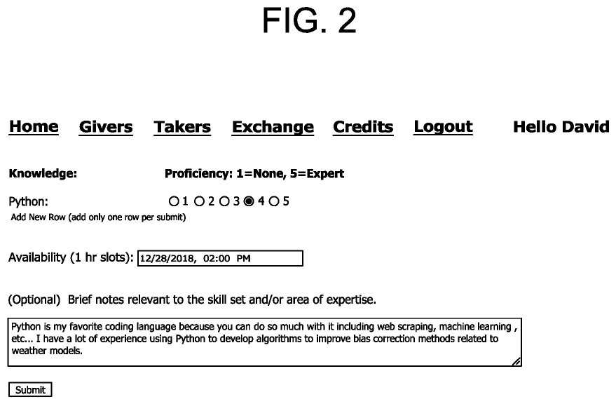

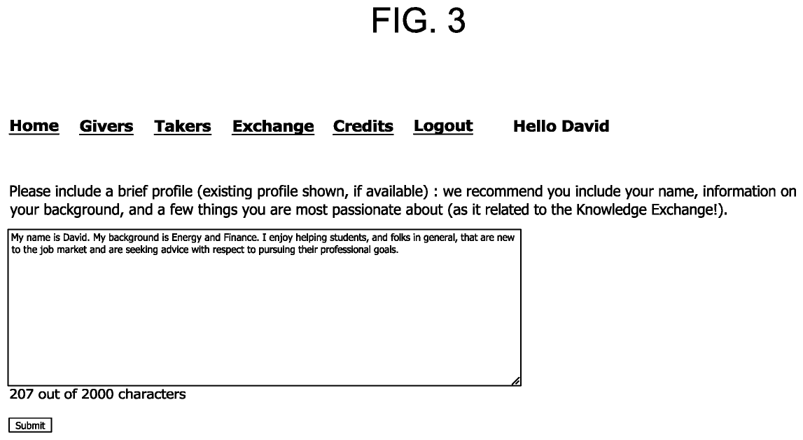

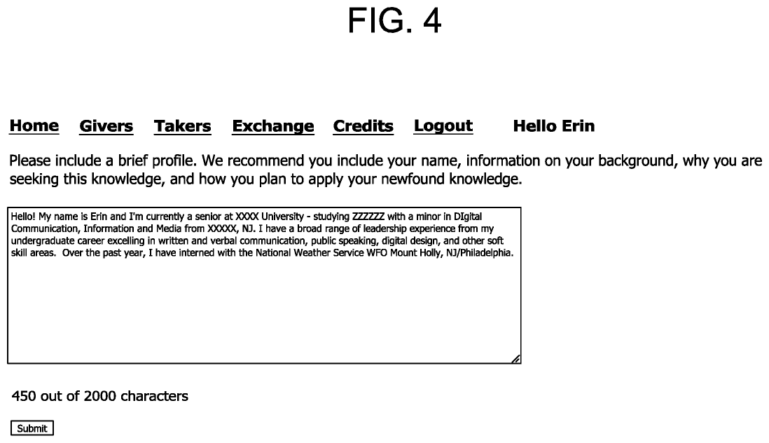

The system and method disclosed herein provides a platform for the exchange of information between mentors (or “Givers”) and mentees (or “Takers”). Givers start by creating a profile as shown on FIG. 3. The Giver will then provide a checklist of skill sets and knowledge he or she is proficient in (such as python programming, statistics, or machine learning) as shown in FIG. 2. The Giver also provides his or her availability (in one hour slots) as shown in FIG. 2. Finally, as shown in FIG. 2 the Giver also has the option of providing ‘notes’ (more details) on each skill set. The Taker also starts by creating a profile as shown in FIG. 4. The Taker then goes to the Exchange webpage as shown in FIG. 1 to find the knowledge that Taker requires. If he or she finds a match he or she will click on a calendar invite and confirm the meeting. If he or she does not find a match he or she can email the administrator of the website and the administrator will attempt to help that Taker find a match by other means, or may add the Taker's request to a backlog that is triggered if and when that knowledge or skill set becomes available from a Giver.

After the calendar invite is sent, the Giver and Taker will determine how they want to ‘transfer the knowledge’ or connect, that is, for example, via email, phone, or in-person.

Volunteer credits will be assigned by the system and method of this invention to Givers (for each hour shared) and tracked so that those Givers are recognized for his or her contribution. It is suggested in this system and method, but not required, that Takers also ‘give back’ by mentoring in the future (that is, give an hour, take an hour).

A rating system is constructed by the present system and method to better evaluate Givers and Takers but initially an ‘honor system’ model will be applied. That is, the Giver will provide information on his or her knowledge and proficiency.

As may be appreciated, the specification of the invention set forth herein relates in great part to the preferred embodiment of the invention, but other embodiments of the instant invention are also to be understood to be covered hereby.

What is claimed is:

1. A system for coordinating and providing for mentoring services from mentors to mentees comprising:
a panoply of computing devices;
a network connecting said devices;
a computer program running on a platform; and
a website accessible on said network running under the control of said program and accessible to said devices,
whereby potential mentors create profiles on such website using such devices for access by potential mentees using such devices by which said program coordinates the matching of potential mentors with potential mentees so that said mentors may provide mentoring services to said mentees.

2. The system of claim 1 in which said network is the internet.

3. The system of claim 1 in which said platform is selected from the group comprising:
a server and the cloud.

4. The system of claim 1 in which such devices are selected from the group comprising:
laptop computers, desktop computers, tablets, and smartphones.

5. A method for coordinating and providing for mentoring services for mentors to mentees comprising the steps of:
creating by potential mentors of information relating to mentor skill sets and profiles describing areas of proficiency and availability for providing mentoring services in said areas;
posting of said mentor information on a website resident on a network;
creating by potential mentees of information relating to mentee profiles describing areas of needed mentoring services and availability for receiving said mentoring services in said areas;
posting said mentee profiles on said website; and
matching said mentor availability in an area of needed mentoring by a mentee said availability of said mentee,
whereby mentoring services are provided by said mentor to said mentee in said area of needed mentoring services at mutually available times.
